(19) United States
(12) Patent Application Publication
(10) Pub. No.: US 2026/0341298 A1
(43) Pub. Date: Oct. 29, 2026

(54) LEARNING APPARATUS, CONVERTER, LEARNING METHOD, CONVERSION METHOD AND PROGRAM

(71) Applicant: NTT, Inc., Tokyo (JP)

(72) Inventors: Chihiro WATANABE, Musashino-shi (JP); Hirokazu KAMEOKA, Musashino-shi (JP)

(73) Assignee: NTT, Inc., Tokyo (JP)

(21) Appl. No.: 19/110,283

(22) PCT Filed: Sep. 27, 2022
(86) PCT No.: PCT/JP2022/035806

§ 371 Date: Mar. 10, 2025

(51) Int. Cl. G10L 25/18; G10L 21/00

(52) U.S. Cl. CPC G10L 25/18; G10L 21/00

(57) ABSTRACT

One aspect of the present invention is a learning device including a control unit that learns a mathematical model of a learning target on the basis of a speaker label indicating a speaker, mel spectrogram information indicating a mel spectrogram of voice uttered by the speaker, and an F0 label indicating an F0 pattern of the voice, in which the mathematical model includes speaker label generation processing for generating a speaker label, F0 label generation processing for generating an F0 label, encoding processing for extracting a feature amount of a mel spectrogram, and decoding processing for estimating a mel spectrogram indicated by a decoding target by decoding the decoding target including the feature amount, and the control unit updates the mathematical model on the basis of a result of execution of the mathematical model.

### TECHNICAL FIELD

The present invention relates to a learning apparatus, a converter, a learning method, a conversion method, and a program.

### BACKGROUND ART

As a method for converting a voice signal into a signal having a different characteristic regarding a certain feature, there is a voice conversion technique. For example, as a method of such voice conversion, there is a method in which a voice signal by a certain speaker is converted so as to be like an utterance by a different speaker. In recent years, a speaker conversion method based on a frame of deep learning and the like have been proposed (Non Patent Literature 1).

### CITATION LIST

### Non Patent Literature

Non Patent Literature 1: Hirokazu Kameoka, Takuhiro Kaneko, Kou Tanaka, Nobukatsu Hojo. “ACVAE-VC: Non-Parallel Voice Conversion With Auxiliary Classifier Variational Autoencoder”. IEEE/ACM Transactions on Audio, Speech and Language Processing. Vol. 27, No. 9. pp. 1432-1443. 2019

### SUMMARY OF INVENTION

### Technical Problem

However, there is a case where accuracy of voice conversion is not necessarily high in techniques proposed so far.

In view of the above circumstances, an object of the present invention is to provide a technique for improving accuracy of voice conversion.

### Solution to Problem

One aspect of the present invention is a learning device including a control unit that learns a mathematical model of a learning target on a basis of a speaker label indicating a speaker, mel spectrogram information indicating a mel spectrogram of voice uttered by the speaker, and an F0 label indicating an F0 pattern of the voice, in which the speaker label, the mel spectrogram information, and the F0 label are input to the mathematical model, the mathematical model is a mathematical model including speaker label generation processing for generating a speaker label indicating a speaker determined on a basis of a predetermined rule, F0 label generation processing for generating an F0 label indicating an F0 pattern determined on a basis of a predetermined rule, encoding processing for extracting a feature amount of the mel spectrogram, and decoding processing that is processing on a decoding target that is a processing target including at least the feature amount and is processing for estimating a mel spectrogram indicated by the decoding target by decoding the decoding target, the mathematical model is executed in the learning, in the learning, the decoding processing is executed on a first decoding target that is a decoding target including the feature amount and the speaker label and the F0 label input to the mathematical model, and a second decoding target that is a decoding target including the feature amount, a result of the speaker label generation processing, and a result of the F0 label generation processing, and the control unit updates the mathematical model on a basis of a result of execution of the mathematical model.

One aspect of the present invention is a conversion device including a conversion control unit that executes: acquisition processing for acquiring a speaker label indicating a speaker, mel spectrogram information indicating a mel spectrogram of voice uttered by the speaker, and an F0 label indicating an F0 pattern of the voice; and conversion processing for converting a mel spectrogram indicated by the mel spectrogram information obtained in the acquisition processing into a mel spectrogram in which a speaker is a speaker indicated by the speaker label obtained in the acquisition processing and an F0 pattern is an F0 pattern indicated by the F0 label obtained in the acquisition processing using encoding processing and decoding processing in a mathematical model that is learned obtained by a learning device including a control unit that learns the mathematical model of a learning target on a basis of a speaker label, mel spectrogram information, and an F0 label, in which the speaker label, the mel spectrogram information, and the F0 label are input to the mathematical model, the mathematical model is a mathematical model including speaker label generation processing for generating a speaker label indicating a speaker determined on a basis of a predetermined rule, F0 label generation processing for generating an F0 label indicating an F0 pattern determined on a basis of a predetermined rule, the encoding processing for extracting a feature amount of the mel spectrogram, and the decoding processing that is processing on a decoding target that is a processing target including at least the feature amount and is processing for estimating a mel spectrogram indicated by the decoding target by decoding the decoding target, and the mathematical model is executed in the learning, in the learning, the decoding processing is executed on a first decoding target that is a decoding target including the feature amount and the speaker label and the F0 label input to the mathematical model, and a second decoding target that is a decoding target including the feature amount, a result of the speaker label generation processing, and a result of the F0 label generation processing, and the control unit updates the mathematical model on a basis of a result of execution of the mathematical model.

One aspect of the present invention is a learning method including a control step of learning a mathematical model of a learning target on a basis of a speaker label indicating a speaker, mel spectrogram information indicating a mel spectrogram of voice uttered by the speaker, and an F0 label indicating an F0 pattern of the voice, in which the speaker label, the mel spectrogram information, and the F0 label are input to the mathematical model, the mathematical model is a mathematical model including speaker label generation processing for generating a speaker label indicating a speaker determined on a basis of a predetermined rule, F0 label generation processing for generating an F0 label indicating an F0 pattern determined on a basis of a predetermined rule, encoding processing for extracting a feature amount of the mel spectrogram, and decoding processing that is processing on a decoding target that is a processing target including at least the feature amount and is processing for estimating a mel spectrogram indicated by the decoding target by decoding the decoding target, the mathematical model is executed in the learning, in the learning, the decoding processing is executed on a first decoding target that is a decoding target including the feature amount and the speaker label and the F0 label input to the mathematical model, and a second decoding target that is a decoding target including the feature amount, a result of the speaker label generation processing, and a result of the F0 label generation processing, and in the control step, the mathematical model is updated on a basis of a result of execution of the mathematical model.

One aspect of the present invention is a conversion method including a conversion control step of executing: acquisition processing for acquiring a speaker label indicating a speaker, mel spectrogram information indicating a mel spectrogram of voice uttered by the speaker, and an F0 label indicating an F0 pattern of the voice; and conversion processing for converting a mel spectrogram indicated by the mel spectrogram information obtained in the acquisition processing into a mel spectrogram in which a speaker is a speaker indicated by the speaker label obtained in the acquisition processing and an F0 pattern is an F0 pattern indicated by the F0 label obtained in the acquisition processing using encoding processing and decoding processing in a mathematical model that is learned obtained by a learning method including a control step of learning the mathematical model of a learning target on a basis of a speaker label, mel spectrogram information, and an F0 label, in which the speaker label, the mel spectrogram information, and the F0 label are input to the mathematical model, the mathematical model is a mathematical model including speaker label generation processing for generating a speaker label indicating a speaker determined on a basis of a predetermined rule, F0 label generation processing for generating an F0 label indicating an F0 pattern determined on a basis of a predetermined rule, the encoding processing for extracting a feature amount of the mel spectrogram, and the decoding processing that is processing on a decoding target that is a processing target including at least the feature amount and is processing for estimating a mel spectrogram indicated by the decoding target by decoding the decoding target, the mathematical model is executed in the learning, in the learning, the decoding processing is executed on a first decoding target that is a decoding target including the feature amount and the speaker label and the F0 label input to the mathematical model, and a second decoding target that is a decoding target including the feature amount, a result of the speaker label generation processing, and a result of the F0 label generation processing, and in the control step, the mathematical model is updated on a basis of a result of execution of the mathematical model.

An aspect of the present invention is a program for causing a computer to function as either the learning device described above or the conversion device described above.

### Advantageous Effects of Invention

According to the present invention, it is possible to improve accuracy of voice conversion.

### BRIEF DESCRIPTION OF DRAWINGS

FIG. 1 is a diagram illustrating an example of a configuration of a conversion system according to an embodiment.

FIG. 2 is a diagram illustrating an example of a hardware configuration of a learning device according to the embodiment.

FIG. 3 is a flowchart illustrating an example of a flow of processing executed by the learning device according to the embodiment.

FIG. 4 is a diagram illustrating an example of a hardware configuration of a conversion device according to the embodiment.

FIG. 5 is a flowchart indicating an example of flow of processing executed by the conversion device according to the embodiment.

FIG. 6 is a diagram indicating an example of results of a first test according to the embodiment.

### DESCRIPTION OF EMBODIMENTS

### Embodiment

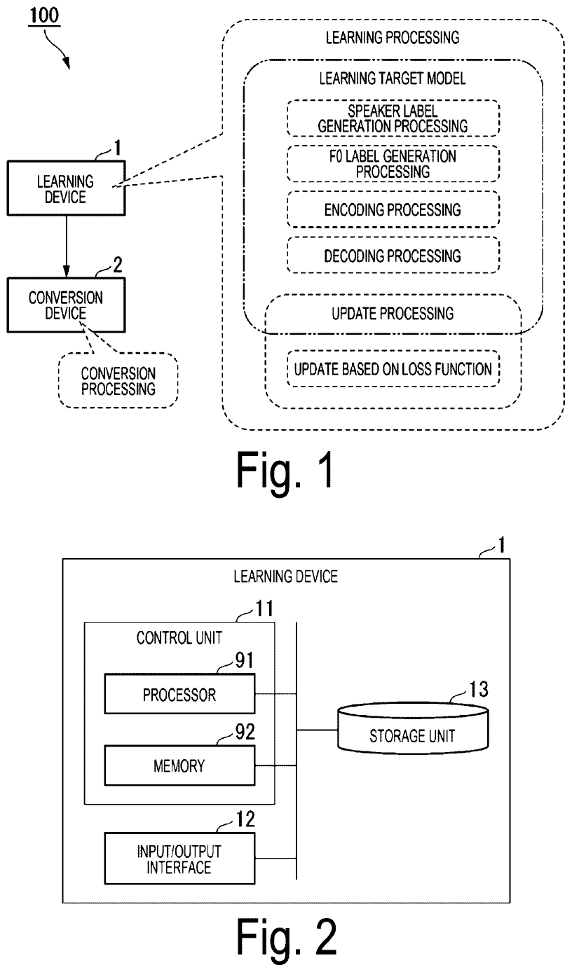

FIG. 1 is a diagram illustrating an example of a configuration of a conversion system 100 according to an embodiment. The conversion system 100 includes a learning device 1 and a conversion device 2. The learning device 1 updates a mathematical model of a learning target (hereinafter referred to as “learning target model”) by performing learning. Specifically, the learning target model is a mathematical model including a mathematical model used for voice conversion.

Note that the voice conversion in the conversion system 100 is specifically conversion of a mel spectrogram. On the basis of a mel spectrogram after conversion, the waveform of converted voice can be estimated using a vocoder. Therefore, as the conversion accuracy of a mel spectrogram is higher, the accuracy of voice conversion is higher. Therefore, increasing the accuracy of conversion of a mel spectrogram leads to improvement of the accuracy of voice conversion. Furthermore, in the conversion system 100, the mathematical model used for voice conversion is more specifically a mathematical model used for conversion of a mel spectrogram.

The learning device 1 learns the learning target model until a predetermined end condition regarding learning (hereinafter referred to as “learning end condition”) is satisfied. The learning end condition may be, for example, a condition that the number of times of updating of the learning target model has reached a predetermined number of times, or may be, for example, a condition that a change in the learning target model due to the update is smaller than a predetermined change.

The conversion device 2 executes conversion of a mel spectrogram using a part of processing included in the learned learning target model. The term “learned” means a time point when the learning end condition is satisfied. Therefore, the learned mathematical model means a mathematical model at a time point when the learning end condition is satisfied.

### <Regarding Learning Device 1>

The learning device 1 executes learning processing. The learning processing is processing for learning a learning target model using a set of a speaker label, mel spectrogram information, and an F0 label as a processing target until the learning end condition is satisfied on the basis of the processing target. The speaker label is information indicating a speaker. The mel spectrogram information is information indicating a mel spectrogram of voice uttered by a speaker. The mel spectrogram indicated by the mel spectrogram information may be a logarithmic mel spectrogram. The F0 label is information indicating the F0 pattern of voice uttered by a speaker.

In the learning processing, the learning target model is executed. The speaker label, the mel spectrogram information, and the F0 label that are processing targets of the learning processing are input to the learning target model. Hereinafter, the speaker label input to the learning target model is referred to as a first speaker label. Hereinafter, the F0 label input to the learning target model is referred to as a first F0 label.

The learning target model includes speaker label generation processing, F0 label generation processing, encoding processing, and decoding processing. When the learning target model is executed, the speaker label generation processing, the F0 label generation processing, the encoding processing, and the decoding processing are executed. Therefore, in the learning processing, the speaker label generation processing, the F0 label generation processing, the encoding processing, and the decoding processing are executed.

The speaker label generation processing is processing for generating a speaker label indicating a speaker determined on the basis of a predetermined rule. Hereinafter, a result of the speaker label generation processing is referred to as a second speaker label. That is, the second speaker label is a speaker label indicating a speaker determined on the basis of a predetermined rule by executing the speaker label generation processing. The predetermined rule in the speaker label generation processing is, for example, a rule that the speaker is randomly determined from speaker candidates prepared in advance.

The F0 label generation processing is processing for generating an F0 label indicating an F0 pattern determined on the basis of a predetermined rule. Hereinafter, a result of the F0 label generation processing is referred to as a second F0 label. That is, the second F0 label is an F0 label indicating an F0 pattern determined on the basis of a predetermined rule by executing the F0 label generation processing.

The predetermined rule in the F0 label generation processing is, for example, a rule that the F0 label generated in the F0 label generation processing is an F0 label randomly determined from F0 label candidates prepared in advance. The predetermined rule in the F0 label generation processing is, for example, a rule that the F0 label generated in the F0 label generation processing indicates a result of applying random noise to the F0 pattern indicated by the first F0 label.

The encoding processing is processing for extracting a feature amount of a mel spectrogram indicated by the mel spectrogram information input to the learning target model. The decoding processing is processing on a decoding target that is a processing target and is processing for estimating a mel spectrogram indicated by the decoding target by performing decoding on the decoding target. The decoding target is information including at least the feature amount (hereinafter referred to as “mel feature amount”) obtained by the encoding processing.

In the learning processing, the decoding processing is executed on a plurality of decoding targets. One of the decoding targets includes the mel feature amount, the first speaker label, and the first F0 label. Hereinafter, the decoding target including the mel feature amount, the first speaker label, and the first F0 label is referred to as a first decoding target.

The other decoding target includes the mel feature amount, the second speaker label, and the second F0 label. Hereinafter, the decoding target including the mel feature amount, the second speaker label, and the second F0 label is referred to as a second decoding target.

In the learning processing, processing for updating the learning target model (hereinafter referred to as “update processing”) is performed on the basis of a result of execution of the learning target model. The learning target model is updated such that at least a first update condition and a second update condition are satisfied.

The first update condition is a condition that the learning target model is updated such that a difference between the result of the decoding processing on the first decoding target and the mel spectrogram indicated by the mel spectrogram information input to the learning target model is small.

The second update condition is a condition that, if a difference condition is satisfied, the learning target model is updated such that the result of the decoding processing on the first decoding target is different from the result of the decoding processing on the second decoding target. The difference condition is a condition that at least one of a condition that the first speaker label and the second speaker label are different from each other or a condition that the first F0 label and the second F0 label are different from each other is satisfied. Note that the encoding processing and the decoding processing are processing in which content is updated by the update processing.

### First Example of Update Processing

A first example of the update processing will be described. The learning target model further includes speaker label estimation processing and F0 label estimation processing. The speaker label estimation processing is processing in which a result of the decoding processing is used as a processing target and is processing for estimating the speaker label on the basis of the processing target. The F0 label estimation processing is processing in which the result of the decoding processing is used as a processing target and is processing for estimating the F0 label on the basis of the processing target.

In the first example of the update processing, the speaker label estimation processing in which a second decoding result is used as a processing target and the F0 label estimation processing in which the second decoding result is used as a processing target are executed. The second decoding result is a result of the decoding processing on the second decoding target.

In the first example of the update processing, the learning target model is updated on the basis of a loss function including at least a reconfiguration error, a second speaker label loss function, and a second F0 label loss function.

The reconfiguration error indicates a difference between a first decoding result and the mel spectrogram information input to the learning target model. The first decoding result is a result of the decoding processing on the first decoding target.

The second speaker label loss function indicates a difference between a result of the speaker label estimation processing in which the second decoding result is used as a processing target and the second speaker label. The second F0 label loss function indicates a difference between a result of the F0 label estimation processing in which the second decoding result is used as a processing target and the second F0 label.

In the first example of the update processing, the learning target model is updated such that a difference indicated by the reconfiguration error, a difference indicated by the second speaker label loss function, and a difference indicated by the second F0 label loss function are small. As described above, in the first example of the update processing, update in which at least the first update condition and the second update condition are satisfied is performed.

### Second Example of Update Processing

A second example of the update processing will be described. Similarly to the first example of the update processing, the learning target model further includes speaker label estimation processing and F0 label estimation processing. In the second example of the update processing, the speaker label estimation processing in which the second decoding result is used as a processing target and the F0 label estimation processing in which the second decoding result is used as a processing target are executed.

In the second example of the update processing, the speaker label estimation processing in which the first decoding result is used as a processing target and the speaker label estimation processing in which the mel spectrogram information input to the learning target model is used as a processing target are further executed.

In the second example of the update processing, the learning target model is updated on the basis of a loss function including at least a reconfiguration error, a second speaker label loss function, a second F0 label loss function, and a first speaker label loss function.

The first speaker label loss function indicates the sum of a first sub-difference and a second sub-difference. The first sub-difference is a difference between a result of the speaker label estimation processing in which the first decoding result is used as a processing target and the first speaker label. The second sub-difference is a difference between a result of the speaker label estimation processing in which the mel spectrogram information input to the learning target model is used as a processing target and the first speaker label.

In the second example of the update processing, the learning target model is updated such that a difference indicated by the reconfiguration error, a difference indicated by the second speaker label loss function, a difference indicated by the second F0 label loss function, and a difference indicated by the first speaker label loss function are small. As described above, in the second example of the update processing, update in which at least the first update condition and the second update condition are satisfied is performed.

### Third Example of Update Processing

A third example of the update processing will be described. Similarly to the first example of the update processing, the learning target model further includes speaker label estimation processing and F0 label estimation processing. In the third example of the update processing, the speaker label estimation processing in which the second decoding result is used as a processing target and the F0 label estimation processing in which the second decoding result is used as a processing target are executed.

In the third example of the update processing, the F0 label estimation processing in which the first decoding result is used as a processing target and the F0 label estimation processing in which the mel spectrogram information input to the learning target model is used as a processing target are further executed.

In the third example of the update processing, the learning target model is updated on the basis of a loss function including at least a reconfiguration error, a second speaker label loss function, a second F0 label loss function, and a first F0 label loss function.

The first F0 label loss function indicates the sum of a third sub-difference and a fourth sub-difference. The third sub-difference is a difference between a result of the F0 label estimation processing in which the first decoding result is used as a processing target and the first F0 label. The fourth sub-difference is a difference between a result of the F0 label estimation processing in which the mel spectrogram information input to the learning target model is used as a processing target and the first F0 label.

In the third example of the update processing, the learning target model is updated such that a difference indicated by the reconfiguration error, a difference indicated by the second speaker label loss function, a difference indicated by the second F0 label loss function, and a difference indicated by the first F0 label loss function are small. As described above, in the third example of the update processing, update in which at least the first update condition and the second update condition are satisfied is performed.

### Fourth Example of Update Processing

A fourth example of the update processing will be described. Similarly to the first example of the update processing, the learning target model further includes speaker label estimation processing and F0 label estimation processing. In the fourth example of the update processing, the speaker label estimation processing in which the second decoding result is used as a processing target and the F0 label estimation processing in which the second decoding result is used as a processing target are executed.

In the fourth example of the update processing, the speaker label estimation processing in which the first decoding result is used as a processing target and the speaker label estimation processing in which the mel spectrogram information input to the learning target model is used as a processing target are further executed. In the fourth example of the update processing, the F0 label estimation processing in which the first decoding result is used as a processing target and the F0 label estimation processing in which the mel spectrogram information input to the learning target model is used as a processing target are further executed.

In the fourth example of the update processing, the learning target model is updated on the basis of a loss function including at least a reconfiguration error, a second speaker label loss function, a second F0 label loss function, a first speaker label loss function, and a first F0 label loss function.

In the fourth example of the update processing, the learning target model is updated such that a difference indicated by the reconfiguration error, a difference indicated by the second speaker label loss function, a difference indicated by the second F0 label loss function, a difference indicated by the first speaker label loss function, and a difference indicated by the first F0 label loss function are small. As described above, in the fourth example of the update processing, update in which at least the first update condition and the second update condition are satisfied is performed.

Note that the speaker label estimation processing and the F0 label estimation processing may be included in the learning target model. In such a case, the content of the speaker label estimation processing and the F0 label estimation processing may be updated in a case where the learning target model is updated by the update processing.

As described above, in any of the first to fourth examples of the update processing, update is performed using the loss function including at least the reconfiguration error, the second speaker label loss function, and the second F0 label loss function.

### <Regarding Conversion Device 2>

As described above, the conversion device 2 executes conversion of a mel spectrogram using a part of processing included in the learned learning target model. Specifically, a part of the processing included in the learned learning target model used by the conversion device 2 is the encoding processing and the decoding processing in the learned learning target model. Hereinafter, the encoding processing in the learned learning target model is referred to as learned encoding processing. Hereinafter, the decoding processing in the learned learning target model is referred to as learned decoding processing.

The conversion device 2 executes conversion processing. The conversion processing is processing for converting a conversion source mel spectrogram into a conversion destination mel spectrogram on the basis of the conversion source mel spectrogram, the speaker label, and the F0 label. The conversion destination mel spectrogram is processing for performing conversion into a mel spectrogram in which the F0 pattern is the F0 pattern indicated by the F0 label and the speaker is the speaker indicated by the speaker label. The conversion source mel spectrogram is a mel spectrogram that is a conversion source.

Note that the speaker of the mel spectrogram means a speaker who has uttered voice indicated by the mel spectrogram.

In the conversion processing, the learned encoding processing on the conversion source mel spectrogram is executed. In the conversion processing, the learned decoding processing is executed on a decoding target including the result of the learned encoding processing on the conversion source mel spectrogram, the speaker label, and the F0 label. The result of the learned decoding processing is a mel spectrogram after conversion obtained by the conversion processing.

FIG. 2 is a diagram illustrating an example of a hardware configuration of the learning device 1 according to the embodiment. The learning device 1 includes a control unit 11 including a processor 91 such as a central processing unit (CPU) and a memory 92 connected by a bus, and executes a program. The learning device 1 functions as a device including the control unit 11, an input/output interface 12, and a storage unit 13 by executing a program.

More specifically, the processor 91 reads the program stored in the storage unit 13, and stores the read program in the memory 92. The learning device 1 functions as a device including the control unit 11, the input/output interface 12, and the storage unit 13 by the processor 91 executing the program stored in the memory 92.

The control unit 11 controls operation of various functional units included in the learning device 1. The control unit 11 executes, for example, the learning processing. The control unit 11, for example, acquires information input to the input/output interface 12 by controlling operation of the input/output interface 12. The control unit 11, for example, causes a result of the learning processing to be output to a predetermined output destination by controlling the operation of the input/output interface 12. The result of the learning processing caused to be output to a predetermined output destination by the control unit 11 controlling the operation of the input/output interface 12 is, for example, a computer program indicating processing that is a part of the processing included in the learned learning target model and is used for conversion of a mel spectrogram by the conversion device 2.

The input/output interface 12 inputs and outputs various types of information. The input/output interface 12 includes a display device such as a cathode ray tube (CRT) display, a liquid crystal display, or an organic electro-luminescence (EL) display as an interface that outputs information. The interface that outputs information may be configured as an interface that connects these display devices to the learning device 1.

The input/output interface 12 includes an input device such as a mouse, a keyboard, or a touch panel as an interface that receives input of information. The interface that outputs information may be configured as an interface that connects these input devices to the learning device 1.

Furthermore, the input/output interface 12 includes a communication device. The input/output interface 12 communicates with an external device by wired or wireless communication using the communication device. The external device is, for example, the conversion device 2. The input/output interface 12 transmits the computer program indicating processing that is a part of the processing included in the learned learning target model and used for conversion of a mel spectrogram by the conversion device 2 to the conversion device 2 by communication using the communication device. Therefore, the conversion device 2 is an example of a predetermined output destination.

The external device may be, for example, an external storage device such as a hard disk drive or a solid state drive (SSD). The computer program indicating processing that is a part of the processing included in the learned learning target model and is used for conversion of a mel spectrogram by the conversion device 2 may be output to an external storage device. Therefore, the external storage device is an example of a predetermined output destination.

A processing target of the learning processing is input to the input/output interface 12 via the input device or the communication device.

The storage unit 13 is configured using a computer-readable storage medium device (non-transitory computer-readable recording medium) such as a magnetic hard disk device or a semiconductor storage device. The storage unit 13 stores various types of information regarding the learning device 1. The storage unit 13 stores, for example, a result of processing executed by the control unit 11. Therefore, the storage unit 13 stores, for example, a result of the learning processing. The storage unit 13 stores, for example, a processing target of the learning processing.

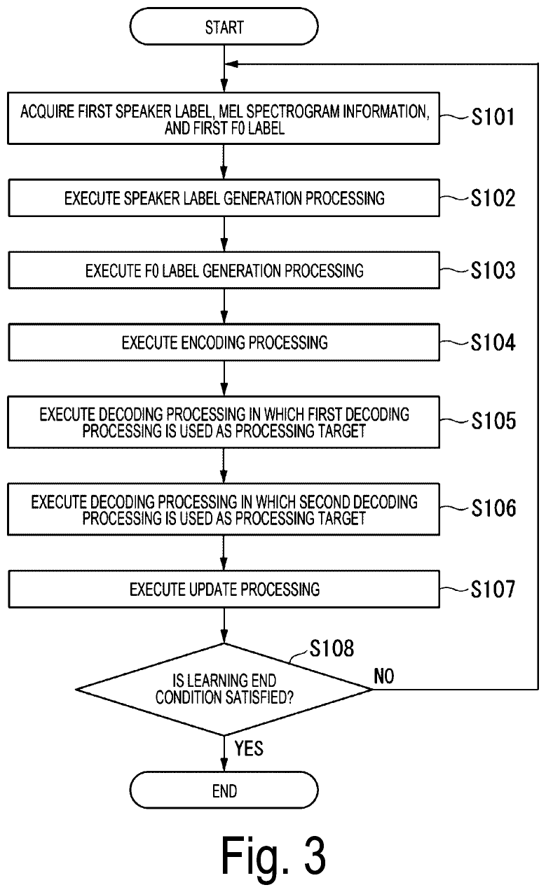

FIG. 3 is a flowchart illustrating an example of a flow of processing executed by the learning device 1 according to the embodiment.

The control unit 11 inputs the first speaker label, the mel spectrogram information, and the first F0 label to the learning target model (step S101). That is, the first speaker label, the mel spectrogram information, and the first F0 label are input to the learning target model. The control unit 11 acquires the first speaker label, the mel spectrogram information, and the first F0 label via the input/output interface 12, for example.

Next, the control unit 11 executes the speaker label generation processing (step S102). The second speaker label is obtained by executing the processing in step S102. Next, the control unit 11 executes the F0 label generation processing (step S103). The second F0 label is obtained by executing the processing in step S103. Next, the control unit 11 executes the encoding processing in which the mel spectrogram information acquired in step S101 is used as a processing target (step S104). The mel feature amount is obtained by executing step S104.

Next, the control unit 11 executes the decoding processing on a decoding target including the mel feature amount obtained in step S104 and the first speaker label and the first F0 label obtained in step S101 (that is, first decoding target) (step S105). Next, the control unit 11 executes the decoding processing on a decoding target including the mel feature amount obtained in step S104, the second speaker label obtained in step S102, and the second F0 label obtained in step S103 (that is, second decoding target) (step S106).

Next, the control unit 11 updates the learning target model such that at least the first update condition and the second update condition are satisfied on the basis of the result of the processing in step 105 and the result of the processing in step S106 (step S107). Next, the control unit 11 determines whether or not the learning end condition is satisfied (step S108).

If the learning end condition is not satisfied (step S108: NO), the processing returns to step S101. On the other hand, if the learning end condition is satisfied (step S108: YES), the processing ends. The learning target model at a time point when the processing ends is the learned learning target model.

Note that the processing of step S105 may be executed at any timing as long as the timing is before execution of the processing of step S107 and after execution of step S104. The processing of step S106 may be executed at any timing as long as the timing is after execution of step S102, step S103, and step S104 and before execution of step S107.

Furthermore, the processing in step S104 may be executed at any timing as long as the timing is after execution of step S101 and before execution of processing executed first in processing in step S105 or step S106. The processing of step S103 may be executed at any timing as long as the timing is after execution of the processing of step S101 and before execution of step S106.

The processing of step S102 may be executed at any timing as long as the timing is after execution of the processing of step S101 and before execution of step S106. In this manner, pieces of processing from steps S101 to S108 may be executed at any timing as long as the timing does not violate the law of causality.

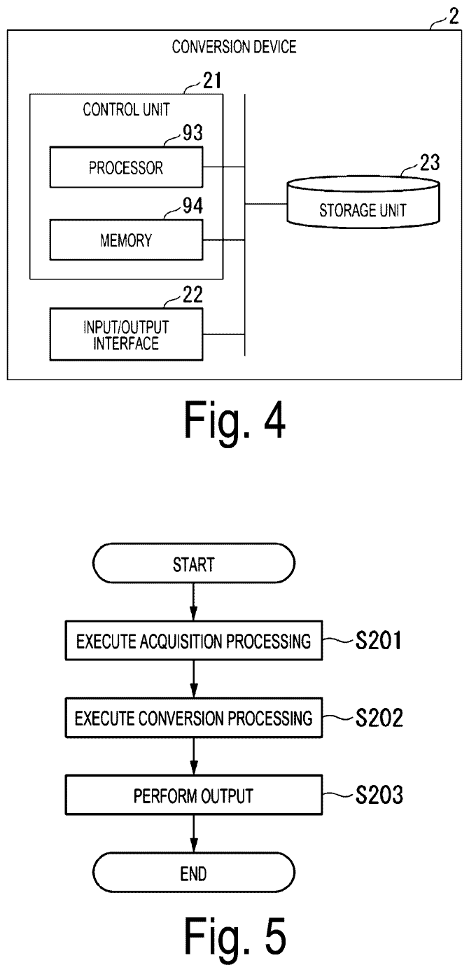

FIG. 4 is a diagram illustrating an example of a hardware configuration of the conversion device 2 according to the embodiment. The conversion device 2 includes a control unit 21 including a processor 93 such as a CPU and a memory 94 connected via a bus, and executes a program. The conversion device 2 functions as a device including the control unit 21, an input/output interface 22, and a storage unit 23 by executing a program.

More specifically, the processor 93 reads the program stored in the storage unit 23, and stores the read program in the memory 94. The conversion device 2 functions as a device including the control unit 21, the input/output interface 22, and the storage unit 23 by the processor 93 executing the program stored in the memory 94.

The control unit 21 controls operation of various functional units included in the conversion device 2. The control unit 21 executes, for example, the conversion processing. The control unit 21 acquires information input to the input/output interface 22. The control unit 11, for example, causes a result of the conversion processing to be output by controlling the operation of the input/output interface 22.

The input/output interface 22 inputs and outputs various types of information. The input/output interface 22 includes a display device such as a CRT display, a liquid crystal display, or an organic EL display as an interface that outputs information. The interface that outputs information may be configured as an interface that connects these display devices to the conversion device 2.

The input/output interface 22 includes an input device such as a mouse, a keyboard, or a touch panel as an interface that receives input of information. The interface that outputs information may be configured as an interface that connects these input devices to the conversion device 2.

Furthermore, the input/output interface 22 includes a communication device. The input/output interface 22 communicates with an external device by wired or wireless communication using the communication device. The external device is, for example, the learning device 1. The input/output interface 22 acquires, from the learning device 1, the computer program indicating processing that is a part of the processing included in the learned learning target model and used for conversion of a mel spectrogram by the conversion device 2 by communication using the communication device.

The external device may be, for example, an external storage device such as a hard disk drive or a solid state drive (SSD). The computer program indicating processing that is a part of the processing included in the learned learning target model and is used for conversion of a mel spectrogram by the conversion device 2 may be read from an external storage device.

The conversion source mel spectrogram, the speaker label, and the F0 label are input to the input/output interface 22 via the input device or the communication device. The control unit 21 acquires the conversion source mel spectrogram, the speaker label, and the F0 label input to the input/output interface 22.

The storage unit 23 is configured using a computer-readable storage medium device (non-transitory computer-readable recording medium) such as a magnetic hard disk device or a semiconductor storage device. The storage unit 23 stores various types of information regarding the conversion device 2. The storage unit 23 stores, for example, a result of processing executed by the control unit 21. Therefore, the storage unit 23 stores, for example, a result of the conversion processing. The storage unit 23 stores, for example, a processing target of the conversion processing.

FIG. 5 is a flowchart indicating an example of flow of processing executed by the conversion device 2 according to the embodiment.

The control unit 21 executes acquisition processing (step S201). The acquisition processing is processing for acquiring the conversion source mel spectrogram, the speaker label, and the F0 label. For example, the user inputs the conversion source mel spectrogram, the speaker label, and the F0 label to the input/output interface 22. In this case, the control unit 21 acquires the conversion source mel spectrogram, the speaker label, and the F0 label input to the input/output interface 22 by executing the acquisition processing.

Next, the control unit 21 executes the conversion processing based on information obtained in step S201 (step S202). By the conversion processing being executed, a mel spectrogram in which the F0 pattern is the F0 pattern indicated by the F0 label and the speaker is the speaker indicated by the speaker label is obtained on the basis of the conversion source mel spectrogram. Next, the control unit 21 causes the input/output interface 22 to output the mel spectrogram obtained in step S202 by controlling the operation of the input/output interface 22 (step S203).

### Experiment Results

An example of experiment results using the conversion system 100 will be described. In experiments, in each learning step, a mini-batch including 16 samples was used, and parameters of an entire neural network model were updated on the basis of a backpropagation method. In the experiments, a set of mel spectrogram information indicating a logarithmic mel spectrogram defined from utterances by four people, an F0 label, and a speaker label was used as one sample. In the experiments, 5000 epochs of learning were performed. Parallel WaveGAN (see Reference Literature 1) was used as a vocoder for conversion of test data.
Reference Literature 1: R. Yamamoto, E. Song, and J-M. Kim. Parallel WaveGAN: A fast waveform generation model based on generative adversarial networks with multi-resolution spectrogram. In ICASSP, pages 6199-6203, 2020.

The experiments were conducted using CMU Arctic speech databases (see Reference Literature 2) composed of the four speakers.
Reference Literature 2: J. Kominek and A. W. Black. The CMU Arctic speech databases. In SSW5-2004, pages 223-224, 2004.

In the experiments, a test was performed in which the logarithmic F0 pattern was converted by a designated amount β. The test data used in the experiments was test data not used for learning.

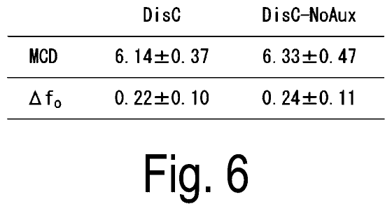

In the experiments, two types of experiments that are an experiment in the case of β=−log (1.5) and an experiment in the case of β=log (1.5) were performed. In the experiments, a mel spectrogram was converted for each value of β with respect to voice of each of the four speakers. The experimental results in FIG. 6 to be described below indicate average values of results in the case of β=−log (1.5) and results in the case of β=log (1.5) with respect to all the test data of the four speakers. Therefore, the experimental results in FIG. 6 indicate average values of eight types of results.

Note that, more specifically, experiments were performed regarding the two types of β for each of the four speakers, and an experiment using 132 pieces of test data was performed for each set of a speaker and β. That is, in the experiments, a total of 2*4*132=1056 experiments were performed. The experimental results in FIG. 6 indicate average values of 1056 experiment results. In the experiments, speakers indicated by speaker labels were speakers of mel spectrograms indicated by mel spectrogram information. Therefore, the speakers were not converted in the experiments performed this time.

In the experiments, as the mel spectrograms, mel spectrograms of voice in which information of silent sections of the beginning and the end in the time direction is removed were used.

In the experiments, Vector Quantised-Variational AutoEncoder (VQ-VAE) (see Reference Literature 3) was used for the encoding processing.
Reference Literature 3: A. van den Oord, O. Vinyals, and K. Kavukcuoglu. Neural discrete representation learning. In NeurIPS, volume 30, pages 6309-6318, 2017.

In the experiments, in the F0 label generation processing, the following processing was performed as a random resampling method. That is, processing was performed in which an F0 label of input test data is set to pᵢ, a logarithmic F0 label after random resampling is set to zero for a time i that satisfies pᵢ=0, and the logarithmic F0 label after random resampling is set to log (pᵢ)+β₀ for a time i that does not satisfy pᵢ=0. However, β₀ is a random value sampled from a uniform distribution of a section of 0.3 or more and less than 3.

In the experiments, in the speaker label generation processing, sampling from a discrete uniform distribution on a set {1, 2, 3, 4} was performed. Note that the set {1, 2, 3, 4} indicates each of all the four speakers, “1” indicates one of the four speakers, “2” indicates one of the remaining three speakers, “3” indicates one of the remaining two speakers, and “4” indicates the last speaker.

In the experiments, a root mean square error Δf₌₀ o between two logarithmic F0 patterns was used as an objective index for conversion of an F0 pattern. In the experiments, mel-cepstral distortion (MCD) was used as an objective index for conversion of voice quality (that is, conversion of a speaker). In both evaluations, endpoint-free Dynamic Time Warping (DTW) was applied in order to eliminate deviation in the time direction between a target feature amount and a feature amount after conversion. Then, after matching in the time direction is performed by DTW being applied, these indexes were calculated.

In the experiments, for Δf₀, an error between a target logarithmic F0 pattern and a logarithmic F0 pattern of converted voice was measured. Note that the logarithmic F0 pattern of converted voice was defined from the converted voice using a WORLD pitch extractor (see Reference Literature 4).
Reference Literature 4: M. Morise, F. Yokomori, and K. Ozawa. WORLD: A vocoder-based high-quality speech synthesis system for real-time applications. IEICE Transactions on Information and Systems E99. D (7): 1877-1884, 2016.

In the experiments, MCD between voice before conversion and voice after conversion by the decoding processing was acquired. The converted voice is a result of the decoding processing.

FIG. 6 is a diagram indicating an example of results of the experiments in the embodiment. “DisC” means the conversion processing using the learned encoding processing and the decoding processing obtained by the learning device 1. “DisC-NoAux” means the conversion processing using the learned encoding processing and decoding processing of a result of performing learning using only a reconfiguration error as a loss function in learning by the learning device 1. Therefore, “DisC-NoAux” is an example of a comparison target for evaluating the performance of “DisC”.

The results in FIG. 6 indicate that the accuracy of conversion of a mel spectrogram (that is, voice conversion) by “DisC” is higher than that of conversion of a mel spectrogram by “DisC-NoAux”.

The learning device 1 according to the embodiment configured as described above learns the learning target model using the F0 label, and performs learning so as to generate a result indicating a difference in the F0 label. As a result, the learning device 1 can obtain a mathematical model that obtains a mel spectrogram appropriately reflecting a change in the F0 label as compared with a case of learning not using the F0 label. Furthermore, in the learning, learning of the encoding processing for extracting a mel feature amount that is a feature amount of a mel spectrogram is also performed. Therefore, the learning device 1 can obtain a mathematical model that estimates a mel spectrogram using the mel feature amount more appropriate than a mel feature amount in a case where the mel feature amount is manually acquired.

If a more appropriate mel feature amount is used, the accuracy of estimation of a mel spectrogram by the decoding processing is also high. For these reasons, the learning device 1 can improve the accuracy of conversion of a mel spectrogram. Then, as described above, if the accuracy of conversion of a mel spectrogram is improved, the accuracy of voice conversion is improved. Therefore, the fact that the learning device 1 can improve the accuracy of conversion of a mel spectrogram means that the learning device 1 can improve the accuracy of voice conversion.

Furthermore, the conversion device 2 according to the embodiment configured as described above obtains a mel spectrogram in which the F0 pattern is the F0 pattern indicated by the conversion destination F0 label on the basis of the conversion source mel spectrogram using the learned encoding processing and decoding processing obtained by the learning device 1. Accordingly, the conversion device 2 can improve the accuracy of voice conversion.

Furthermore, the conversion system 100 according to the embodiment configured as described above includes the learning device 1. Accordingly, the conversion system 100 can improve the accuracy of voice conversion.

### (Modifications)

Note that, in the learning processing, a zero label may be further used. The zero label is information indicating an F0 pattern having a value of 0. That is, the zero label is information indicating silence. In such a case, in the learning processing, the decoding processing is executed on a decoding target including the mel feature amount, the first speaker label, and the zero label (hereinafter, referred to as “zero-th decoding target”). In such a case, in the learning processing, the F0 label estimation processing is executed on the zero-th decoding result. The zero-th decoding result is a result of the decoding processing on the zero-th decoding target. In such a case, the loss function may include, for example, a function indicating a difference between the result of the decoding processing on the zero-th decoding target and the zero label (hereinafter, the function is referred to as “zero-th F0 label loss function”).

### Example of Loss Function

An example of the loss function is indicated by a mathematical expression. The loss function is expressed by, for example, the following Formula (1).

$$\begin{matrix}[ Math . 1 ] & \\ ℒ = {ℒ}_{like} + {ℒ}_{reg} + {ℒ}_{aux} & ( 1 )\end{matrix}$$

$$\begin{matrix}[ Math . 2 ] & \\ {ℒ}_{like} = \frac{1}{2 FT} {\sum }_{i = 1}^{F} {\sum }_{j = 1}^{T} [ log {\hat{V}}_{ij} + log ( 2 π ) + \frac{1}{{\hat{V}}_{ij}} {( {X}_{ij} - {\hat{M}}_{ij} )}^{2} ] & ( 2 )\end{matrix}$$

$$\begin{matrix}[ Math . 3 ] & \\ {ℒ}_{reg} = \frac{1}{2} ( {ℒ}_{reg ( P )} + {ℒ}_{reg ( S )} ) & ( 3 )\end{matrix}$$

$$\begin{matrix}[ Math . 4 ] & \\ {ℒ}_{aux} = \frac{1}{2} ( {ℒ}_{{P}_{ext}} + {ℒ}_{CLS} ) & ( 4 )\end{matrix}$$

$$\begin{matrix}[ Math . 5 ] & \\ {ℒ}_{reg ( P )} = \frac{1}{2 T} {\sum }_{i = 1}^{T} [ \vert {( {\hat{p}}_{rand} )}_{i} - {( {p}_{rand} )}_{i} \vert + \vert {( {\hat{p}}_{0} )}_{i} - {( {p}_{0} )}_{i} \vert ] & ( 5 )\end{matrix}$$

$$\begin{matrix}[ Math . 6 ] & \\ {ℒ}_{reg ( S )} = CE ( {\hat{s}}_{rand} , {s}_{( 2 )} ) & ( 6 )\end{matrix}$$

$$\begin{matrix}[ Math . 7 ] & \\ {ℒ}_{{P}_{ext}} = \frac{1}{2 T} {\sum }_{i = 1}^{T} [ \vert {\hat{p}}_{i} - {p}_{i} \vert + \vert {( {\hat{p}}_{rec} )}_{i} - {p}_{i} \vert ] & ( 7 )\end{matrix}$$

$$\begin{matrix}[ Math . 8 ] & \\ {ℒ}_{CLS} = \frac{1}{2} [ CE ( \hat{s} , {s}_{( 1 )} ) + CE ( {\hat{s}}_{rec} , {s}_{( 1 )} ) ] & ( 8 )\end{matrix}$$

$$\begin{matrix}[ Math . 9 ] & \\ {s}_{( 1 )} = [ \begin{matrix}s & s & … & s\end{matrix} ] ∈ {ℝ}^{{N}_{S}} & ( 9 )\end{matrix}$$

$$\begin{matrix}[ Math . 10 ] & \\ {s}_{( 2 )} = [ \begin{matrix}{s}_{rand} & {s}_{rand} & … & {s}_{rand}\end{matrix} ] ∈ {ℝ}^{{N}_{S}} & ( 10 )\end{matrix}$$

CE (⋅, ⋅) represents a cross entropy loss. F represents the size in the frequency direction of an input mel spectrogram. T represents the size in the time direction of the input mel spectrogram. In Formula (2), i corresponds to the i-th element in the frequency direction. In Formula (2), j corresponds to the j-th element in the time direction. Therefore, Vᵢⱼ with a hat symbol represents an element that is the i-th in the frequency direction and the j-th in the time direction of a matrix V representing variance in output by a decoder. Xᵢⱼ represents an element that is the i-th in the frequency direction and the j-th in the time direction of an input logarithmic mel spectrogram. Mᵢⱼ with a hat symbol represents an element that is the i-th in the frequency direction and the j-th in the time direction of a matrix M representing an average in output by a decoder. Ns is any natural number.

p_{rand} with a hat symbol represents a result of the F0 label estimation processing in which the second decoding result is used as a processing target. p_{rand} without a hat symbol represents the second F0 label. p₀ with a hat symbol represents a result of the F0 label estimation processing in which the zero-th decoding result is used as a processing target. p₀ without a hat symbol represents the zero label.

p with a hat symbol represents a result of the F0 label estimation processing in which the mel spectrogram information input to the learning target model is used as a processing target. The i-th element of p with a hat symbol is represented as pᵢ. p without a hat symbol represents the F0 label input to the learning target model. The i-th element of p without a hat symbol is represented by pᵢ without a hat symbol.

p_{rec} with a hat symbol represents a result of the F0 label estimation processing in which the first decoding result is used as a processing target.

s_{rand} with a hat symbol represents a result of the speaker label estimation processing in which the second decoding result is used as a processing target. s_{rand} without a hat symbol represents the second speaker label. s with a hat symbol represents a result of the speaker label estimation processing in which the mel spectrogram information input to the learning target model is used as a processing target. s without a hat symbol represents the speaker label input to the learning target model.

s_{red} with a hat symbol represents a result of the speaker label estimation processing in which the first decoding result is used as a processing target.

Formula (2) is an example of the reconfiguration error. The first term in the Σ symbol on the right side of Formula (5) is an example of the second F0 label loss function. The second term in the Σ symbol on the right side of Formula (5) is an example of the zero-th F0 label loss function. Formula (6) is an example of the second speaker label loss function.

Formula (7) is an example of the first F0 label loss function. The first term in the Σ symbol on the right side of Formula (7) is an example of the fourth sub-difference. The second term in the Σ symbol on the right side of Formula (7) is an example of the third sub-difference.

Formula (8) is an example of the first speaker label loss function. The first term in the Σ symbol on the right side of Formula (8) is an example of the second sub-difference. The second term in the Σ symbol on the right side of Formula (8) is an example of the first sub-difference.

Note that Formulas (1) to (10) are merely examples, and for example, in Formula (1), each function on the right side may be multiplied by a predetermined weight.

Note that each of the learning device 1 and the conversion device 2 may be implemented by using a plurality of information processing devices communicably connected to each other via a network. In this case, the functional units included in each of the learning device 1 and the conversion device 2 may be implemented in a distributed manner in the plurality of information processing devices.

Note that the control unit 21 included in the conversion device 2 is an example of a conversion control unit.

Note that all or some of the functions of each of the learning device 1 and the conversion device 2 may be implemented by using hardware such as an application specific integrated circuit (ASIC), a programmable logic device (PLD), or a field programmable gate array (FPGA). The program may be recorded in a computer-readable recording medium. The computer-readable recording medium is, for example, a portable medium such as a flexible disk, a magneto-optical disk, a ROM, or a CD-ROM, or a storage device such as a hard disk built in a computer system. The program may be transmitted via an electrical communication line.

Although the embodiment of the present invention has been described in detail with reference to the drawings, specific configurations are not limited to the embodiment, and include design and the like within the scope of the present invention without departing from the gist of the present invention.

### REFERENCE SIGNS LIST

100 Conversion system
1 Learning device
2 Conversion device
11 Control unit
12 Input/output interface
13 Storage unit
21 Control unit
22 Input/output interface
23 Storage unit
91 Processor
92 Memory
93 Processor
94 Memory

1. A learning device comprising:
a processor;
a storage medium having computer program instructions stored thereon, wherein the computer program instruction, when executed by the processor, perform processing of:
learning a mathematical model of a learning target on a basis of a speaker label indicating a speaker, mel spectrogram information indicating a mel spectrogram of voice uttered by the speaker, and an F0 label indicating an F0 pattern of the voice,
wherein the speaker label, the mel spectrogram information, and the F0 label are input to the mathematical model,
the mathematical model is a mathematical model including speaker label generation processing for generating a speaker label indicating a speaker determined on a basis of a predetermined rule, F0 label generation processing for generating an F0 label indicating an F0 pattern determined on a basis of a predetermined rule, encoding processing for extracting a feature amount of the mel spectrogram, and decoding processing that is processing on a decoding target that is a processing target including at least the feature amount and is processing for estimating a mel spectrogram indicated by the decoding target by decoding the decoding target,
the mathematical model is executed in the learning,
in the learning, the decoding processing is executed on a first decoding target that is a decoding target including the feature amount and the speaker label and the F0 label input to the mathematical model, and a second decoding target that is a decoding target including the feature amount, a result of the speaker label generation processing, and a result of the F0 label generation processing, and
updating the mathematical model on a basis of a result of execution of the mathematical model.

2. The learning device according to claim 1,
wherein the mathematical model is updated such that
a first update condition that the mathematical model is updated such that a difference between a result of the decoding processing on the first decoding target and a mel spectrogram indicated by the mel spectrogram information is small, and
a second update condition that the mathematical model is updated such that a result of the decoding processing on the first decoding target and a result of the decoding processing on the second decoding target are different in a case where a difference condition that at least one of a condition that the speaker label input to the mathematical model is different from a result of the speaker label generation processing or a condition that the F0 label input to the mathematical model is different from a result of the F0 label generation processing is satisfied
are satisfied.

3. The learning device according to claim 1,
wherein the mathematical model further includes:
speaker label estimation processing that is processing in which a result of the decoding processing is used as a processing target and is for estimating a speaker label on a basis of the processing target; and
F0 label estimation processing that is processing in which a result of the decoding processing is used as a processing target and is for estimating an F0 label on a basis of the processing target, and
the mathematical model is updated such that
a difference indicated by a reconfiguration error indicating a difference between a first decoding result that is a result of the decoding processing on the first decoding target and the mel spectrogram information input to the mathematical model,
a difference indicated by a second speaker label loss function indicating a difference between a result of the speaker label estimation processing in which a second decoding result that is a result of the decoding processing on the second decoding target is used as a processing target and a result of the speaker label generation processing, and
a difference indicated by a second F0 label loss function indicating a difference between a result of the F0 label estimation processing in which a second decoding result that is a result of the decoding processing on the second decoding target is used as a processing target and a result of the F0 label generation processing
are small.

4. (canceled)

5. A learning method comprising:
learning a mathematical model of a learning target on a basis of a speaker label indicating a speaker, mel spectrogram information indicating a mel spectrogram of voice uttered by the speaker, and an F0 label indicating an F0 pattern of the voice,
wherein the speaker label, the mel spectrogram information, and the F0 label are input to the mathematical model,
the mathematical model is a mathematical model including speaker label generation processing for generating a speaker label indicating a speaker determined on a basis of a predetermined rule, F0 label generation processing for generating an F0 label indicating an F0 pattern determined on a basis of a predetermined rule, encoding processing for extracting a feature amount of the mel spectrogram, and decoding processing that is processing on a decoding target that is a processing target including at least the feature amount and is processing for estimating a mel spectrogram indicated by the decoding target by decoding the decoding target,
the mathematical model is executed in the learning,
in the learning, the decoding processing is executed on a first decoding target that is a decoding target including the feature amount and the speaker label and the F0 label input to the mathematical model, and a second decoding target that is a decoding target including the feature amount, a result of the speaker label generation processing, and a result of the F0 label generation processing, and
in the control step, the mathematical model is updated on a basis of a result of execution of the mathematical model.

6. (canceled)

7. A non-transitory computer readable medium which stores a program for causing a computer to function as either the learning device according to claim 1.
